(19) United States
(12) Patent Application Publication
(10) Pub. No.: US 2002/0143817 A1
(43) Pub. Date: Oct. 3, 2002

(54) Presentation of salient features in a page to a visually impaired user

(75) Inventors: Rabindranath Dutta, Austin, TX (US); Karthikeyan Ramamoorthy, Austin, TX (US); Richard Scott Schwerdtfeger, Round Rock, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/820,508

(22) Filed: Mar. 29, 2001

(51) Int. Cl. G06F 15/00

(52) U.S. Cl. 707/513

(57) ABSTRACT

A method, apparatus, and computer program for presenting content in a document. The document is parsed for a salient feature and once a salient feature is located within the document, the salient feature is presented in a manner other than visually.

### BACKGROUND OF THE INVENTION

1. Technical Field

The present invention relates generally to an improved data processing system, and in particular to a method, apparatus, and computer program for presenting data. Still more particularly, the present invention provides a method, apparatus, and computer program for presenting data to a visually impaired user.

2. Description of Related Art:

The Internet, also referred to as an “internetwork”, is a set of computer networks, possibly dissimilar, joined together by means of gateways that handle data transfer and the conversion of messages from the protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Visually impaired users of the Web often rely on tools, such as a talking Web browser. An example of a talking Web browser is the Home Page Reader (HPR), which is available from International Business Machines Corporation (IBM). HPR is a spoken on-ramp to the Information Highway for computer users who are blind or visually impaired. HPR provides Web access by quickly, easily, and efficiently speaking Web page information. HPR provides a simple, easy-to-use interface for navigating and manipulating Web page elements. Using the keyboard to navigate, a user who is blind or who has a visual impairment can hear the full range of Web page content provided in a logical, clear, and understandable manner.

In perceptual psychology, a notion of gestaltic comprehension is present in which the perception is manifested by understanding the whole rather than analyzing small parts and combining them. For example, when a user views a Web page, a quick glance is all that it takes for the user to decide whether to read the Web page. Often the quick glance is focused on the icons and/or pictures and some heavily enlarged or bolded headlines in the Web page. Unfortunately, with users who are blind, the gestaltic perception of the Web page is more difficult. Part of this difficulty occurs because speech is more sequential than vision.

The present invention recognizes that one problem with talking browsers is that an overview of the page is unavailable because this type of Web browser moves from topic to topic in a sequential manner.

Therefore, it would be advantageous to have an improved method, apparatus, and computer program for presenting a Web page to a user who may be visually impaired.

### SUMMARY OF THE INVENTION

The present invention provides a method, apparatus, and computer program for presenting content in a document. The document is parsed for a salient feature and once a salient feature is located within the document, the salient feature is presented in a manner other than visually.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of a browser program in accordance with a preferred embodiment of the present invention;

FIG. 5 is a diagram illustrating components used in presenting salient features of a document in accordance with a preferred embodiment of the present invention;

FIG. 6 is a flowchart of a process used for presenting a document to a visually impaired user in accordance with a preferred embodiment of the present invention; and

FIG. 7 is a a flowchart of a process used for transcoding a page in accordance with a preferred embodiment of the present invention.

### DETAILED DESCRIPTION OF THE PREFERRED EMBODIMENT

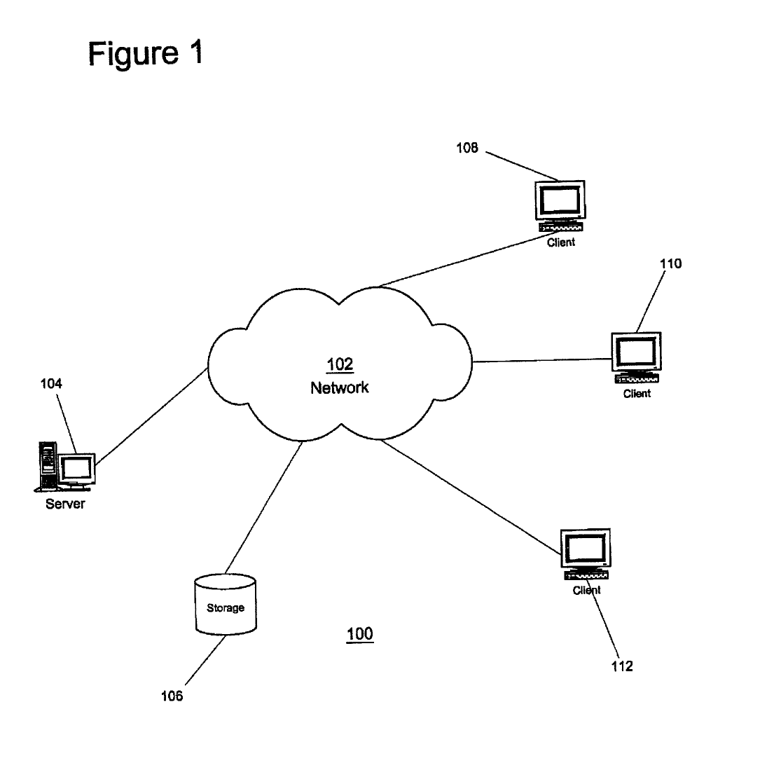

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104.

The mechanism of the present invention allows for a browser executing on a client, such as client 108 to present sufficient portions of content within a document to a visually impaired user so that the visually impaired user is able to obtain an overview of the document. Salient features from a document are selected for presentation to the user. Salient features may include, for example, bold text, italicized text, underlined text, text in a selected color, and text having a certain font size and/or text having a certain position within the document, such as a title, heading, first sentence, etc. These features may be selected in a proxy or a server, such as server 104 and sent via extensible markup language (XML) tags or in resource description framework (RDF) files to the browser at client 108. Alternatively, the mechanism of the present invention may be implemented at client 108 to extract the salient features. When a new page is sent to the user, the user is provided an option as to whether salient features from the new page are to be presented. If the salient features are presented to the user, the user may choose whether the entire page is to be presented.

Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

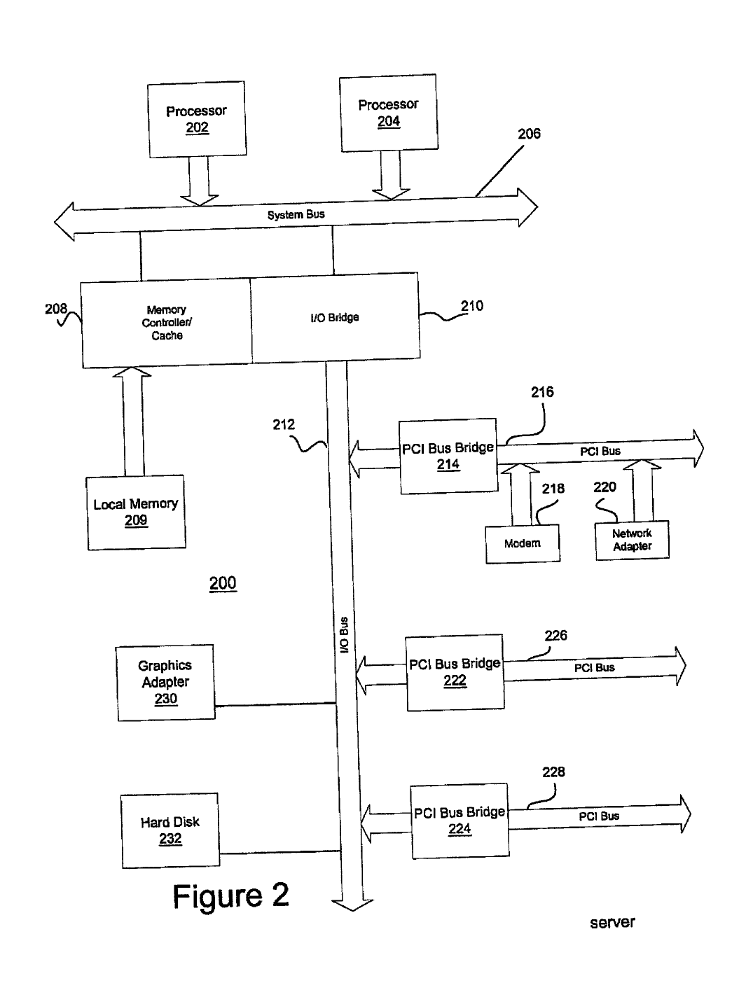

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

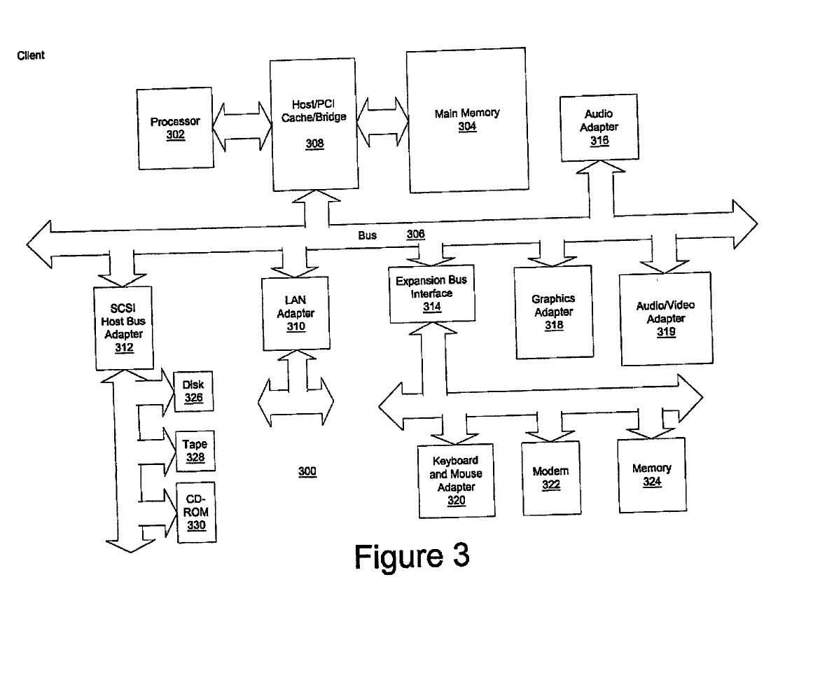

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCT local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300. The operating system may be a commercially available operating system, such as Windows 2000, which is available from Microsoft Corporation. Instructions for the operating system and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

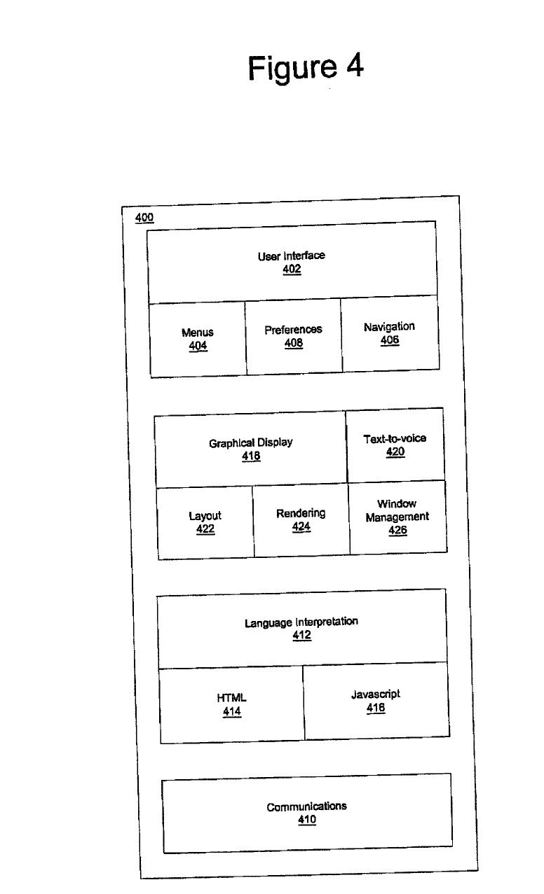

Turning next to FIG. 4, a block diagram of a browser program is depicted in accordance with a preferred embodiment of the present invention. A browser is an application used to navigate or view information or data in a distributed database, such as the Internet or the World Wide Web. In these examples, browser 400 may be located on a data processing system, such as data processing system 300 in FIG. 3.

In this example, browser 400 is a talking Web browser, which may be implemented using the Home Page Reader (HPR), which is available from International Business Machines Corporation (IBM). The processes of the present invention may be implemented within HPR.

As illustrated, browser 400 includes a user interface 402, which includes both a graphical user interface (GUI) and a “visually impaired interface”. The GUI allows a normal user to interface or communicate with browser 400, while the visually impaired interface provides a means for a visually handicapped user to navigate a Web page. This visually impaired interface includes an interface that will speak to a user as well as recognize voice commands and command input from a keyboard. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select Web sites for viewing. For example, navigation 406 may allow a user to see a previous page or a subsequent page relative to the present page. Preferences such as those illustrated in FIG. 4 may be set through preferences 408.

Communications 410 is the mechanism with which browser 400 receives documents and other resources from a network such as the Internet. Further, communications 410 is used to send or upload documents and resources onto a network. In the depicted example, communication 410 uses HTTP. Other protocols may be used depending on the implementation. Documents that are received by browser 400 are processed by language interpretation 412, which includes an HTML unit 414 and a Java Script unit 416. Language interpretation 412 will process a document for presentation on graphical display 418, as well as through text-to-voice unit 420 for visually impaired users. In particular, HTML statements are processed by HTML unit 414 for presentation while Java Script statements are processed by Java Script unit 416.

The processes of the present invention may be implemented within language interpretation 412 to identify salient features in a document. Salient features may include, for example, bold text, italicized text, underlined text, text in a selected color, and text having a certain font size. When implemented within language interpretation 412, these features are extracted from the document for presentation to a visually impaired user. This presentation may take the form of an audio presentation of the summary or a physical tactile presentation, such as generating a Braille version of the summary.

Graphical display 418 includes layout unit 422, rendering unit 424, and window management 426. These units are involved in presenting Web pages to a user based on results from language interpretation 412.

Browser 400 is presented as an example of a browser program in which the present invention may be embodied. In this example, browser 400 may be used by both normal and visually impaired users. Browser 400 is not meant to imply architectural limitations to the present invention. Presently available browsers may include additional functions not shown or may omit functions shown in browser 400. A browser may be any application that is used to search for and present content on a distributed data processing system. Browser 400 may be implemented using known browser applications with the processes of the present invention embodied within it. Such applications include, for example, Netscape Navigator, Microsoft Internet Explorer, and Home Page Reader. Netscape Navigator is available from Netscape Communications Corporation while Microsoft Internet Explorer is available from Microsoft Corporation.

Browser 400 will parse a Web page to select salient features indicted in the Web page through the RDF or other XML-based resource description file, such as an XML schema. These salient features will be presented to the user. XML based markup in the Web page may be used as an annotation. This markup can then be used to reference the corresponding XML-based resource description file that many indicate the item is a salient feature. The salient feature provides a quick overview of the Web page.

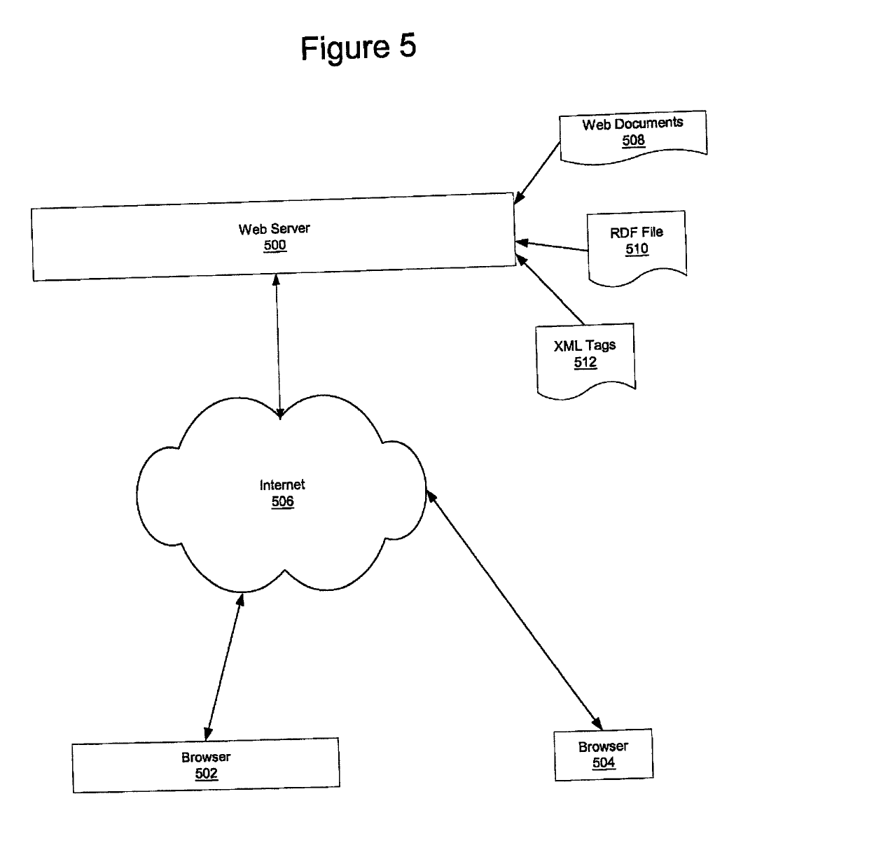

Turning next to FIG. 5, a diagram illustrating components used in presenting salient features of a document is depicted in accordance with a preferred embodiment of the present invention. In this example, Web server 500 provides content to browser 502 and browser 504 through internet 506. In particular, Web documents 508 may be sent to users at browser 502 and browser 504. In these examples, browser 502 and browser 504 may be implemented using a talking Web browser, such as browser 400 in FIG. 4.

Salient features from a document may be presented each time a page in the document is to be presented at a browser, such as browser 502. In one embodiment of the present invention, the salient features are identified by Web server 500 and sent to the user at browser 502.

In the depicted examples, in response to a user request from browser 502, Web server 500 sends a document from Web documents 508 to Web browser 502 for presentation. Each time a page from the document is to be presented to the user, Web server 500 identifies the salient content within that page and generates a RDF file 510 or XML tags 512 and sends the file or tags to browser 502 for presentation to the user. In these examples, the presentation is in a nonvisual manner, such as an audio format or a tactile format. The tactile format may be implemented using a Braille system that generates the appropriate Braille characters based on the content received at browser 502. After the salient features from a page have been presented to the user at browser 502, the user is given an option as to whether the entire page will be presented.

Alternatively, the processes of the present invention may be implemented within browser 502 or another program in a data processing system associated with browser 502. In this implementation, the entire document or a page of the document is received at browser 502 and analyzed to identify the salient features in the document or page. These identified salient features are then presented to the user.

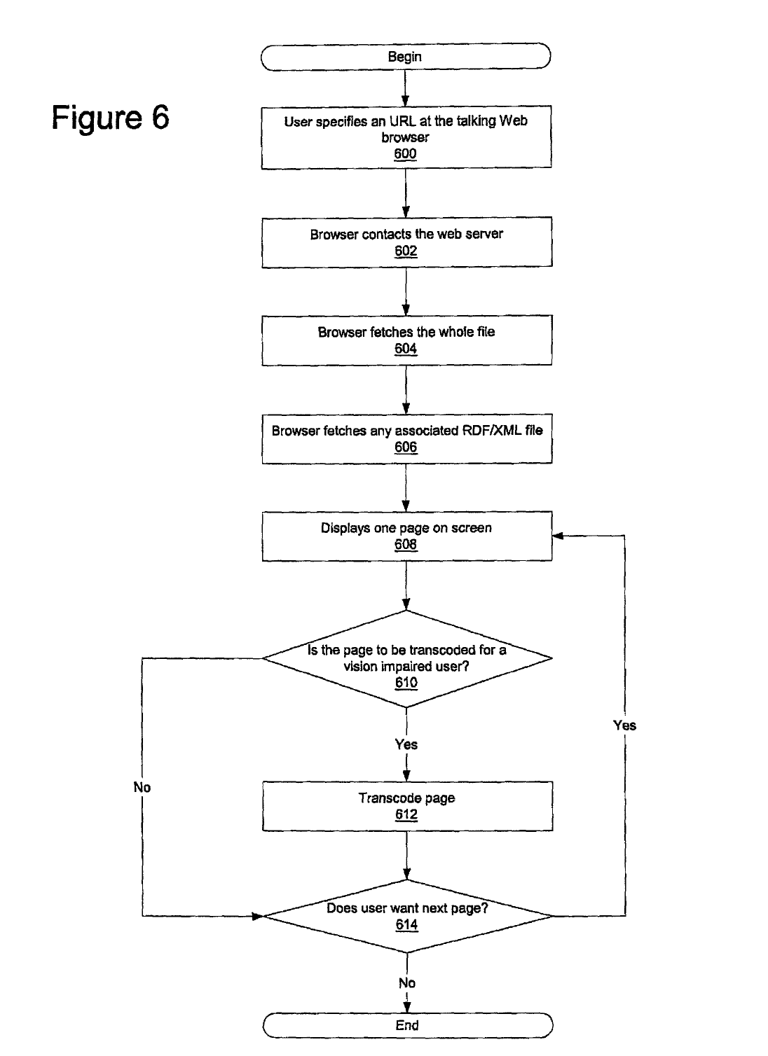

Turning next to FIG. 6, a flowchart of a process used for presenting a document to a visually impaired user is depicted in accordance with a preferred embodiment of the present invention. The process illustrated in FIG. 6 may be implemented in the form of a set of computer code for use in a data processing system. For example, the processes may be implemented as code for use in a proxy located at a server, a proxy located at the client on which the browser is executed, as a plug-in to a browser, or within a browser, such as browser 403 in FIG. 4.

The process begins with the user specifying a URL at a talking Web browser (step 600). Next, the browser contacts the Web server (step 602). The browser fetches the whole file (step 604). Then, the browser fetches any associated RDF/XML file (step 606). An associated RDF or XML file is present if the identification of salient features is provided by the Web server or a proxy server. One page of the document is displayed on a screen within the data processing system on which the talking Web browser is executing (step 608).

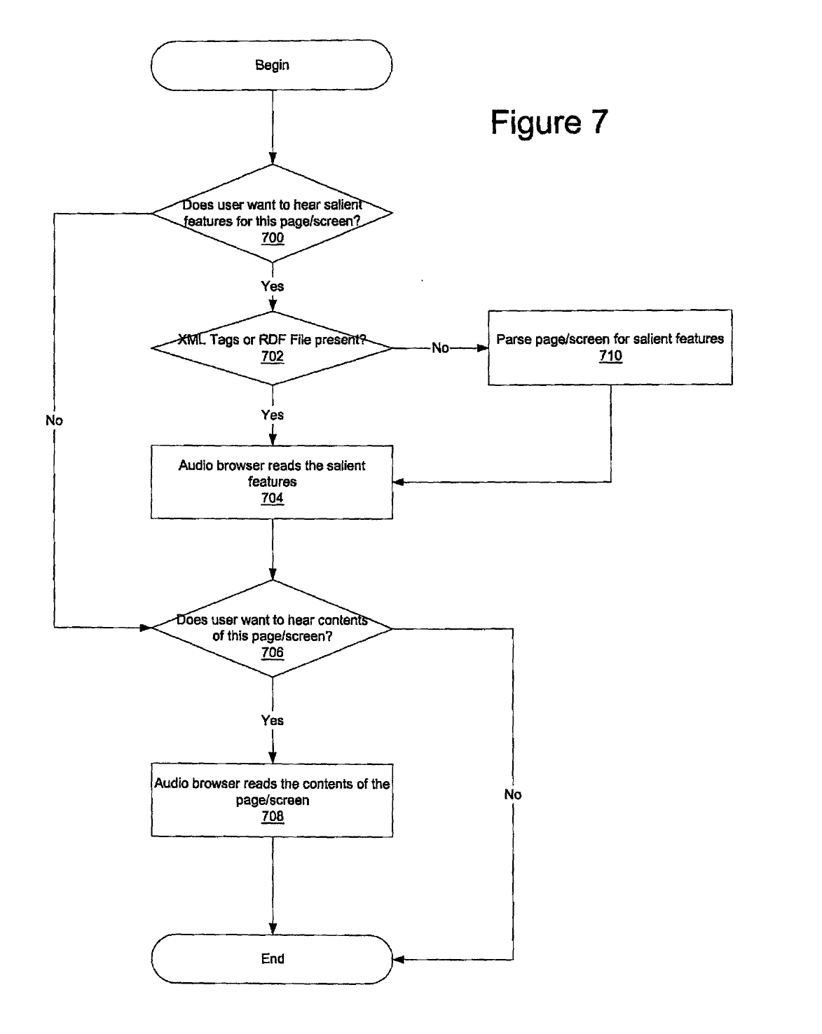

A determination is then made as to whether the page is to be transcoded for a vision impaired user (step 610). Step 610 determines whether salient features are to be identified. This identification may be made in various ways, for example, the user name and password in a message, an IP address, or a login mechanism may be used to determine whether a page is to be transcoded. For example, the user name and password or IP address may be compared with a list or database of user name and passwords or IP addresses to identify whether the page is to be transcoded. If the page is to be transcoded for a vision impaired user, the page is transcoded (step 612). The transcoding process in step 612 is described in more detail in FIG. 7 below. The transcoding in these examples is performed on a page-by-page basis or by some other unit. For example, the unit for transcoding may be a percentage of the entire document or a displayable portion of the document.

Next, a determination is made as to whether the next page is to be presented to the user (step 614). If the next page is not to be presented to the user, the process terminates. Otherwise, the process returns to step 608 as described above. With reference again to step 610, if the page is not to be transcoded for a vision impaired user, the process proceeds to step 614.

Turning next to FIG. 7, a flowchart of a process used for transcoding a page is depicted in accordance with a preferred embodiment of the present invention. The process illustrated in FIG. 7 may be implemented as computer code for software to provide transcoding functions to annotate content for salient features. This process is a more detailed description of step 612 in FIG. 6 above.

The process begins by determining whether the user wants to hear salient features for the page or screen (step 700). If the user wants to hear salient features for the page or screen, a determination is made as to whether XML tags or an RDF file has been received with the document (step 702). If XML tags or an RDF file is present, the talking Web browser reads or audibly presents the salient features (step 704). Next, a determination is made as to whether the user wants to hear the contents of the page or screen (step 706). If the user does want to hear the contents of the page or screen, the audio browser reads the contents of the page or screen (step 708) with the process terminating thereafter. Turning back to step 706, if the user does not want to hear the contents of the page or screen, the process terminates.

With reference again to step 702, if XML tags or an RDF file are absent, the talking Web browser parses the page or screen for salient features (step 710) with the process then proceeding to step 704 as described above.

With reference again to step 700, if the user does not want to hear the salient features of the page or screen, the process proceeds to step 706.

It is important to note that while the present invention has been described in the context of a fully functioning data processing system, those of ordinary skill in the art will appreciate that the processes of the present invention are capable of being distributed in the form of computer instructions forming a computer program in which these instructions may be embodied on various computer readable media. The present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The depicted examples illustrate the presentation of salient features in documents in the form of Web pages. The present invention may be applied to other types of documents other than Web pages. For example, these processes may be applied to traditional word processing documents. Further, although the illustrated example provides an audio presentation of salient features, other mechanisms may be used to present these salient features to a visually impaired user. For example, a tactile format using Braille may be employed to present the salient features. Additionally, the presentation of the salient features may take other forms to aid users who are not visually impaired. For example, the salient features may be highlighted. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for presenting content in a document, the method comprising:
parsing the document for a salient feature; and
responsive to locating the salient feature within the document, presenting the salient feature in a manner other than visually.

2. The method of claim 1 further comprising:
determining whether to present additional portions of the document.

3. The method of claim 2, wherein the determining step is performed after the audibly presenting step.

4. The method of claim 1, wherein the salient feature is at least one of bold text, italicized text, underlined text, text having a selected font size, and text having a selected color.

5. The method of claim 1, wherein the salient feature is presented in an audible manner.

6. The method of claim 1, wherein the salient feature is presented in a tactile manner.

7. The method of claim 1, wherein the document is at least one of an extensible markup language document, a hypertext markup language, and a resource description file.

8. The method of claim 7, wherein the resource description file is one of a resource description format file or an extensible markup language schema file.

9. The method of claim 7, wherein the markup language is at least one of hypertext markup language and resource description framework.

10. The method of claim 1, wherein the presenting step presents the salient feature by highlighting the salient feature within the document instead of presenting the salient feature in a manner other than visually.

11. The method of claim 1, wherein the salient feature is indicated within the document.

12. A data processing system for presenting content in a document, the data processing system comprising:
parsing means for parsing the document for a salient feature; and
presenting means, responsive to locating the salient feature within the document, for presenting the salient feature in a manner other than visually.

13. The data processing system of claim 12 further comprising:
determining means for determining whether to present additional portions of the document.

14. The data processing system of claim 13, wherein the determining means is activated after the audibly presenting means is activated.

15. The data processing system of claim 12, wherein the salient feature is at least one of bold text, italicized text, underlined text, text having a selected font size, and text having a selected color.

16. The data processing system of claim 12, wherein the salient feature is presented in an audible manner.

17. The data processing system of claim 12, wherein the salient feature is presented in a tactile manner.

18. The data processing system of claim 12, wherein the document is a markup language document.

19. A data processing system comprising:
a bus system;
a communications unit connected to the bus system;
a memory connected to the bus system, wherein the memory includes a set of instructions; and
a processing unit connected to the bus system, wherein the processing unit executes the set of instructions to parse the document for a salient feature, and present the salient feature in response to locating a salient feature within the document, in a manner other than visually.

20. The data processing system of claim 19 the processing unit further executes the set of instructions to determine whether to present additional portions of the document.

21. The data processing system of claim 19, wherein the document is a markup language document using a markup language, which is at least one of hypertext markup language and resource description framework.

22. The data processing system of claim 19, wherein the presenting means presents the salient feature by highlighting the salient feature within the document instead of presenting the salient feature in a manner other than visually.

23. A computer program product in a computer readable medium for presenting content in a document, the computer program product comprising:
first instructions for parsing the document for a salient feature; and
second instructions, responsive to locating the salient feature within the document, presenting the salient feature in a manner other than visually.

24. The computer program product of claim 23 further comprising:
third instructions for determining whether to present additional portions of the document.

25. A method in a data processing system for presenting content in a document, comprising:
receiving a request for a document having at least one salient feature;
determining the at least one salient feature; and
in response to the request, presenting at least one of the at least one salient features in a non-visual manner before presenting non-salient content in a non-visual manner.

26. The method of claim 25 wherein determining the at least one salient feature further comprises at least one of receiving the at least one salient feature in a file; determining the at least one salient feature from XML tags; and analyzing the document for at least one of a title, a heading, bold text, italicized text, underlined text, text in a selected color, text having a certain font size, and highlighted text.

27. A method in a data processing system for presenting content in a document, comprising:
receiving a request for a document page;
determining if the page contains at least one salient feature; and
if the page contains at least one salient feature, presenting at least one of the at least one salient features in a non-visual manner before presenting non-salient content in a non-visual manner.

28. A method for processing a requested document, comprising:
analyzing content of the document for at least one salient feature;
denoting the at least one salient feature separately from the content; and
sending the document and the separately denoted at least one salient feature to a requester of the document.

29. The method of claim 28 wherein denoting the at least one salient feature separately from the content further comprises at least one of denoting the at least one salient feature in a file and denoting the at least one salient feature in XML tags.

30. A data processing system for presenting content in a document, comprising:
receiving means for receiving a request for a document having at least one salient feature;
determining means for determining the at least one salient feature; and
presenting means, in response to the request, for presenting at least one of the at least one salient features in a non-visual manner before presenting non-salient content in a non-visual manner.

31. The data processing system of claim 30 wherein determining means further comprises at least one of means for receiving the at least one salient feature in a file; means for determining the et least one salient feature from XML tags; and means for analyzing the document for at least one of a title, a heading, bold text, italicized text, underlined text, text in a selected color, text having a certain font size, and highlighted text.

32. A data processing system for presenting content in a document, comprising:
receiving means for receiving a request for a document page;
determining means for determining if the page contains at least one salient feature; and
presenting means, responsive to the page containing at least one salient feature, for presenting at least one of the at least one salient features in a non-visual manner before presenting non-salient content in a non-visual manner.

33. A data processing system for processing a requested document, comprising:
analyzing means for analyzing content of the document for at least one salient feature;
denoting means for denoting the at least one salient feature separately from the content; and
sending means for sending the document and the separately denoted at least one salient feature to a requester of the document.

34. The date processing system of claim 33 wherein denoting means from further comprises at least one of means for denoting the at least one salient feature in a file and means for denoting the at least one salient feature in XML tags.

35. A computer program product in a computer readable medium for presenting content in a document, comprising:
first instructions for receiving a request for a document having at least one salient feature;
second instructions for determining the at least one salient feature; and
third instructions, in response to the request, for presenting at least ore of the at least one salient features in a non-visual manner before presenting non-salient content in a non-visual manner.

36. The computer program product of claim 35 wherein the second instructions further comprises at least one of sub-instructions for receiving the at least one salient feature in a file; sub-instructions for determining the at least one salient feature from XML tags; and sub-instructions for analyzing the document for at least one of a titles a heading, bold text, italicized text, underlined text, text in a selected color, text having a certain font size, and highlighted text.

37. A computer program product in a computer readable medium for presenting content in a document, comprising:
first instructions for receiving a request for a document page;
second instructions for determining if the page contains at least one salient feature; and
third instructions, if the page contains at least one salient feature, for presenting at least one of the at least one salient features in a non-visual manner before presenting non-salient content in a non-visual manner.

38. A computer program product in a computer readable medium for processing a requested document, comprising:
first instructions for analyzing content of the document for at least one salient feature;
second instructions for denoting the at least one salient feature separately from the content; and
sending the document and the separately denoted at least one salient feature to a requester of the document.

39. The computer program product of claim 38 wherein the second instructions from the content further comprises at least one of sub-instructions for denoting the at least one salient feature in a file and sub-instructions for denoting the at least one salient feature in XML tags.
